(19) United States
(12) Patent Application Publication
(10) Pub. No.: US 2022/0105846 A1
(43) Pub. Date: Apr. 7, 2022

(54) SEAT CUSHION MOUNTED LEVER FOR VEHICLE SEAT OTTOMAN

(71) Applicant: Toyota Boshuku America, Inc., Novi, MI (US)

(72) Inventor: Ryal Glapion, Novi, MI (US)

(21) Appl. No.: 17/493,029

(22) Filed: Oct. 4, 2021

Related U.S. Application Data
(60) Provisional application No. 63/087,712, filed on Oct. 5, 2020.

(51) Int. Cl. B60N 2/90; B60N 2/02

(52) U.S. Cl. CPC B60N 2/995; B60N 2/0284

(57) ABSTRACT

A vehicle seat assembly includes a seat cushion including a side portion and an ottoman located near a front of the seat cushion. The ottoman moves between a retracted position where the ottoman is lowered to lower legs of a vehicle occupant, a fully extended position where the ottoman is raised to raise legs of the vehicle occupant, and a desired position located between the retracted position and the fully extended position. The vehicle seat assembly includes a lever that is actuated to move the ottoman between the retracted position and the fully extended position or the desired position located therebetween. The lever is located on the side portion of the seat cushion.

### CROSS-REFERENCE TO RELATED APPLICATION

This application claims the benefit of U.S. Provisional Application No. 63/087,712 filed on Oct. 5, 2020.

### BACKGROUND

An individual can rest or elevate their legs on an ottoman of a vehicle seat.

### SUMMARY

In one example, a vehicle seat assembly includes a seat cushion including a side portion and an ottoman located near a front of the seat cushion. The ottoman moves between a retracted position where the ottoman is lowered to lower legs of a vehicle occupant, a fully extended position where the ottoman is raised to raise legs of the vehicle occupant, and a desired position located between the retracted position and the fully extended position. The vehicle seat assembly includes a lever that is actuated to move the ottoman between the retracted position and the fully extended position or the desired position located therebetween. The lever is located on the side portion of the seat cushion.

In another embodiment, the vehicle seat assembly includes a seat back that is substantially perpendicular to the seat cushion.

In another embodiment, the seat cushion is located above a side shield, and a plurality of levers are attached to the side shield.

In another embodiment, the plurality of levers comprises a slide lock release lever that is actuated to move a vehicle seat along an axis.

In another embodiment, the axis is substantially horizontal.

In another embodiment, the plurality of levers comprises a reclining lever that is actuated to pivot the seat back relative to the seat cushion about a pivot axis.

In another embodiment, the vehicle seat assembly includes a locking mechanism that retains the ottoman in the desired position.

In another embodiment, the lever includes a spring feature located within the seat cushion that allows the lever to return to an original position once a force applied to the lever to move the ottoman is released.

In another example, a vehicle seat assembly includes a seat cushion including a side portion. The seat cushion is located above a side shield, and a plurality of levers are attached to the side shield. The vehicle seat assembly includes a seat back that is substantially perpendicular to the seat cushion and an ottoman located near a front of the seat cushion. The ottoman moves between a retracted position where the ottoman is lowered to lower legs of a vehicle occupant, a fully extended position where the ottoman is raised to raise legs of the vehicle occupant, and a desired position located between the retracted position and the fully extended position. The vehicle seat assembly includes a locking mechanism that retains the ottoman in the desired position and a lever that is actuated to move the ottoman between the retracted position and the fully extended position. The lever is located on the side portion of the seat cushion. The lever includes a spring feature located within the seat cushion that allows the lever to return to an original position once a force applied to the lever to move the ottoman is released.

In another embodiment, the plurality of levers comprises a slide lock release lever that is actuated to move a vehicle seat along an axis.

In another embodiment, the axis is substantially horizontal.

In another embodiment, the plurality of levers comprises a reclining lever that is actuated to pivot the seat back relative to the seat cushion about a pivot axis.

### BRIEF DESCRIPTION OF THE DRAWINGS

FIG. 1 illustrates an ottoman device of a vehicle seat.

### DETAILED DESCRIPTION

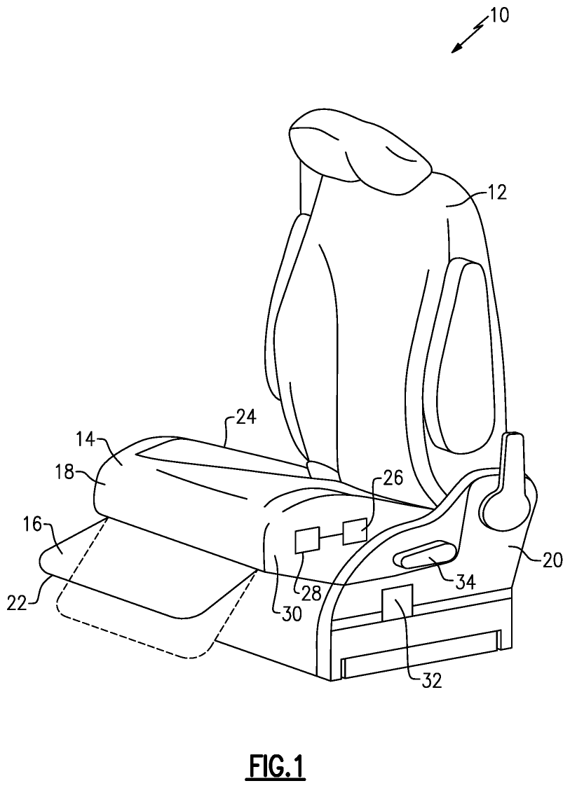

FIG. 1 illustrates a vehicle seat 10. The vehicle seat 10 includes a seat back 12, a seat cushion 14, and an ottoman 16 (or leg rest). The ottoman 16 is attached to or located near a front 18 of the seat cushion 14. A vehicle occupant sits on the seat cushion 14. In one example, the seat cushion 14 is a tip up cushion. The seat cushion 14 is located above a side shield 20. The side shield 20 includes various levers, as described below. The side shield 20 is located on an outer side of the vehicle seat 10.

The ottoman 16 moves between a retracted position (shown in dashed lines) where the ottoman 16 is lowered and a fully extended position (shown in solid lines) where the ottoman 16 is raised to lift the vehicle occupant's legs. In one example, when the ottoman 16 is lowered, a front face 22 the ottoman 16 is substantially perpendicular to an upper face 24 of the seat cushion 14. In one example, when the ottoman 16 is fully extended, the front face 22 of the ottoman 16 is substantial parallel to the upper face 24 of the seat cushion 14. A locking mechanism 26 (shown schematically) in the ottoman 16 secures the ottoman 16 in a desired position. The ottoman 16 can be positioned in any extended position between the retracted position and the fully extended position.

A lever 28 is located on a side 30 of the seat cushion 14 of the vehicle seat 10. The lever 28 is actuated to raise or lower the ottoman 16 to the desired position. The lever 28 is located on the seat cushion 14 and is not located on a fixed part of the vehicle seat 10. When the lever 28 is pulled or actuated, the locking mechanism 26 within the ottoman 16 is released, allowing the ottoman 16 to move. The vehicle occupant can adjust the ottoman 16 to the desired position and to be at the desired height. In one example, the lever 28 is mechanical. In another example, the lever 28 is electrical.

The lever 28 contains a spring feature (not shown) located within the seat cushion 14. When the lever 28 is actuated by the vehicle occupant, the spring feature (not shown) allows the lever 28 to retract to an original position upon release of the lever 28. A force required to cycle and return the lever to the original position requires that the vehicle occupant pull the lever 28 in an outward and upward direction. In one example, there is a correlation between the distance the lever 28 is pulled and the position of the ottoman 16 relative to the seat cushion 14. In one example, when the lever 28 is pulled from the initial position and released before the lever 28 is in fully activated, the ottoman 16 is positioned in an extended position that is between the retracted position and the fully extended position to partially raise the legs of the vehicle occupant.

Several other levers 32 and 34 are attached to the side shield 20. A slide lock release lever 32 is located on the side shield 20 and is actuated to allow the vehicle seat 10 to move in the X direction. In one example, the X direction is substantially horizontal. By actuating the side lock release lever 32, the vehicle seat 10 can move towards a front of a vehicle or towards a rear of the vehicle. A reclining lever 34 is located on the side shield 20 and is engaged to pivot the seat back 12 of the vehicle seat 10 to a desired position relative to the seat cushion 14. The seat back 12 moves about a pivot axis Y that is substantially perpendicular to the axis X.

The location of the lever 28 on the side of the seat cushion 14 provides an ergonomic location of the lever 28 for the seat occupant, preventing over extension when reaching for the lever 28 while in the vehicle seat 10 is in the relaxed position or a laid back position. Locating the lever 28 on the side of the seat cushion 14 instead of on the side shield 20 also reduces clutter on the side shield 20, allowing for a more natural movement of the vehicle occupant when reaching for the desired lever. This reduces complexity of the levers on the side shield 20 by also eliminating the need to combine multiple functions into one lever.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A vehicle seat assembly comprising:
a seat cushion including a side portion;
an ottoman located near a front of the seat cushion, wherein the ottoman moves between a retracted position where the ottoman is lowered to lower legs of a vehicle occupant, a fully extended position where the ottoman is raised to raise legs of the vehicle occupant, and a desired position located between the retracted position and the fully extended position; and
a lever that is actuated to move the ottoman between the retracted position and the fully extended position or the desired position located therebetween, wherein the lever is located on the side portion of the seat cushion.

2. The vehicle seat assembly as recited in claim 1, including a seat back that is substantially perpendicular to the seat cushion.

3. The vehicle seat assembly as recited in claim 1, wherein the seat cushion is located above a side shield, and a plurality of levers are attached to the side shield.

4. The vehicle seat assembly as recited in claim 3, wherein the plurality of levers comprises a slide lock release lever that is actuated to move a vehicle seat along an axis.

5. The vehicle seat assembly as recited in claim 4, wherein the axis is substantially horizontal.

6. The vehicle seat assembly as recited in claim 3, wherein the plurality of levers comprises a reclining lever that is actuated to pivot the seat back relative to the seat cushion about a pivot axis.

7. The vehicle seat assembly as recited in claim 1, including a locking mechanism that retains the ottoman in the desired position.

8. The vehicle seat assembly as recited in claim 1, wherein the lever includes a spring feature located within the seat cushion that allows the lever to return to an original position once a force applied to the lever to move the ottoman is released.

9. A vehicle seat assembly comprising:
a seat cushion including a side portion, wherein the seat cushion is located above a side shield, and a plurality of levers are attached to the side shield;
a seat back that is substantially perpendicular to the seat cushion;
an ottoman located near a front of the seat cushion, wherein the ottoman moves between a retracted position where the ottoman is lowered to lower legs of a vehicle occupant, a fully extended position where the ottoman is raised to raise legs of the vehicle occupant, and a desired position located between the retracted position and the fully extended position;
a locking mechanism that retains the ottoman in the desired position and
a lever that is actuated to move the ottoman between the retracted position and the fully extended position, wherein the lever is located on the side portion of the seat cushion, and the lever includes a spring feature located within the seat cushion that allows the lever to return to an original position once a force applied to the lever to move the ottoman is released.

10. The vehicle seat assembly as recited in claim 9, wherein the plurality of levers comprises a slide lock release lever that is actuated to move a vehicle seat along an axis.

11. The vehicle seat assembly as recited in claim 10, wherein the axis is substantially horizontal.

12. The vehicle seat assembly as recited in claim 9, wherein the plurality of levers comprises a reclining lever that is actuated to pivot the seat back relative to the seat cushion about a pivot axis.
